(19) United States
(12) Patent Application Publication
(10) Pub. No.: US 2019/0254008 A1
(43) Pub. Date: Aug. 15, 2019

(54) Downlink Control Information Format Design In Mobile Communications

(71) Applicant: MediaTek Singapore Pte. Ltd., Singapore (SG)

(72) Inventors: Abdelkader Medles, Cambridge (GB); Jaakko Matias Viertola, Oulu (FI); Mikko Oskari Kyllonen, Oulu (FI); Teemu Tapio Virtanen, Oulu (FI)

(21) Appl. No.: 16/262,686

(22) Filed: Jan. 30, 2019

Related U.S. Application Data
(60) Provisional application No. 62/629,742, filed on Feb. 13, 2018.

(51) Int. Cl. H04W 72/04

(52) U.S. Cl. CPC H04W 72/042

(57) ABSTRACT

Various solutions for downlink control information (DCI) format design with respect to user equipment and network apparatus in mobile communications are described. An apparatus may receive a DCI format from a network node. The apparatus may retrieve an indicator from a fixed position of the DCI format. The apparatus may determine whether a supplementary uplink (SUL) is configured according to the indicator. The apparatus may perform a physical uplink shared channel (PUSCH) transmission according to a determination result.

### CROSS REFERENCE TO RELATED PATENT APPLICATION(S)

The present disclosure is part of a non-provisional application claiming the priority benefit of U.S. Patent Application No. 62/629,742, filed on 13 Feb. 2018, the content of which is incorporated by reference in its entirety.

### TECHNICAL FIELD

The present disclosure is generally related to mobile communications and, more particularly, to downlink control information (DCI) format design with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), supplementary uplink (SUL) transmission is introduced to facilitate uplink transmissions. For example, a low-frequency carrier may be used for SUL in addition to a normal uplink carrier. Due to the lower frequency, the uplink coverage may be improved by transmission on the SUL. The SUL may be configured for performing the physical uplink shared channel (PUSCH) transmission. In order to indicate which of the normal UL or SUL is used for the PUSCH transmission, an indicator bit (e.g., UL/SUL indicator) is introduced for UL grant. The UL/SUL indicator may be placed in the DCI format.

Since the UL and SUL bandwidth size and transmission settings may be different, the DCI number of bits may also be different. However, having different DCI sizes for UL/SUL may increase the blind decoding complexity at the receiver side. Accordingly, in order to reduce the blind decoding complexity, the DCI sizes for UL/SUL may be made equal by adding paddings. However, using paddings and having the UL/SUL indicator position dependent of the DCI size for UL/SUL will create a problem of ambiguity in the DCI decoding. The user equipment (UE) is not able to distinguish the UL/SUL indicator from the paddings. The UE may not know whether the UL/SUL indicator is configured or not. The UE may have difficult to determine whether such DCI is for the UL or the SUL.

Accordingly, how to identify/detect the UL/SUL indicator precisely and avoid ambiguity in the DCI decoding may be important in the newly developed communication system. It is needed to provide proper DCI format design to facilitate the DCI decoding at the UE side.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to DCI format design with respect to user equipment and network apparatus in mobile communications.

In one aspect, a method may involve an apparatus receiving a DCI format from a network node. The method may also involve the apparatus retrieving an indicator from a fixed position of the DCI format. The method may further involve the apparatus determining whether a SUL is configured according to the indicator. The method may further involve the apparatus performing a PUSCH transmission according to a determination result.

In one aspect, an apparatus may comprise a transceiver capable of wirelessly communicating with a network node of a wireless network. The apparatus may also comprise a processor communicatively coupled to the transceiver. The processor may be capable of receiving a DCI format from the network node. The processor may also be capable of retrieving an indicator from a fixed position of the DCI format. The processor may further be capable of determining whether a SUL is configured according to the indicator. The processor may further be capable of performing a PUSCH transmission according to a determination result.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting example scenarios under schemes in accordance with implementations of the present disclosure.

FIG. 5 is a block diagram of an example communication apparatus and an example network apparatus in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to DCI format design with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, supplementary uplink (SUL) transmission is introduced to facilitate uplink transmissions. For example, a low-frequency carrier may be used for SUL in addition to a normal uplink carrier. Due to the lower frequency, the uplink coverage may be improved by transmission on the SUL. The SUL may be configured for performing the PUSCH transmission. In order to indicate which of the normal UL or SUL is used for the PUSCH transmission, an indicator bit (e.g., UL/SUL indicator) is introduced for UL grant. The UL/SUL indicator may be placed in the DCI format.

Since the UL and SUL bandwidth size and transmission settings may be different, the DCI number of bits may also be different. However, having different DCI sizes for UL/SUL may increase the blind decoding complexity at the receiver side. Accordingly, in order to reduce the blind decoding complexity, the DCI sizes for UL/SUL may be made equal by adding zero-padding. For example, for a UE configured with SUL in a cell, if the PUSCH is configured to be transmitted on both the SUL and the non-SUL of the cell and if the number of information bits in format 0_1 for the SUL is not equal to the number of information bits in format 0_1 for the non-SUL, zeros shall be appended to smaller format 0_1 until the payload size equals that of the larger format 0_1.

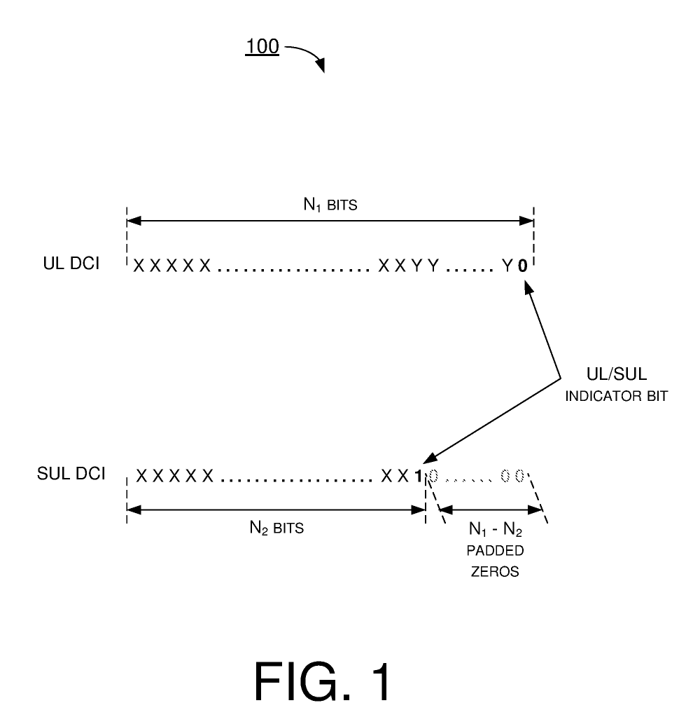

However, using zero-padding and having the UL/SUL indicator position dependent of the DCI size for UL/SUL will create a problem of ambiguity in the DCI decoding. FIG. 1 illustrates an example scenario 100 under schemes in accordance with implementations of the present disclosure. Scenario 100 involves a UE and a network node, which may be a part of a wireless communication network (e.g., an LTE network, an LTE-Advanced network, an LTE-Advanced Pro network, a 5G network, an NR network, an IoT network or an NB-IoT network). The DCI for UL and SUL may comprise different DCI number of bits. For example, the DCI for UL (e.g., UL DCI) may comprise N₁ bits. The DCI for SUL (e.g., SUL DCI) may comprise N₂ bits. N₁ may be greater than N₂. In an event that the YYY . . . Y bits (e.g., N₁−N₂) comprise the value of 100 . . . 0, the UE may not be able to determine whether the DCI is for UL or the SUL due to the ambiguity. Specifically, since the size of the DCI for SUL (e.g., SUL DCI) is smaller than the size of the DCI for UL (e.g., UL DCI), the network node may add the zero-paddings to the end of the DCI for SUL. For example, N₁−N₂ padded zeros may be added to the end of the DCI for SUL. In such case, the last bit of the DCI for SUL (e.g., “0”) is the same as the last bit of the DCI for UL (e.g., “0”). The UE may not know whether the UUSUL indicator is configured or not. The UE may have difficult to determine whether such DCI is for the UL or the SUL.

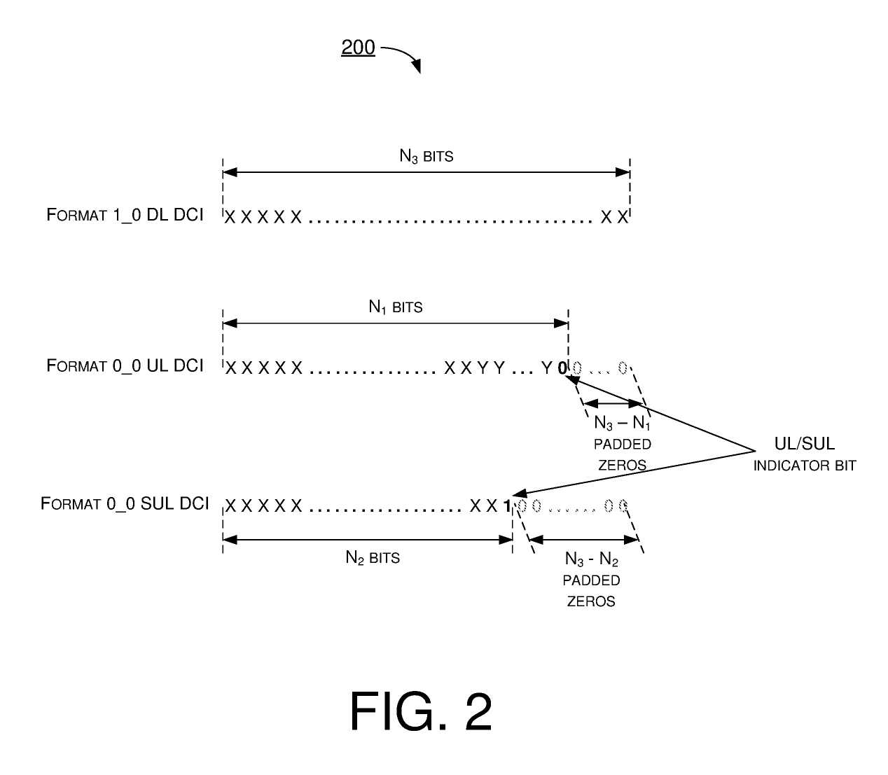

Similar problem may also occur for the case of DCI format 0_0. FIG. 2 illustrates an example scenario 200 under schemes in accordance with implementations of the present disclosure. Scenario 200 involves a UE and a network node, which may be a part of a wireless communication network (e.g., an LTE network, an LTE-Advanced network, an LTE-Advanced Pro network, a 5G network, an NR network, an IoT network or an NB-IoT network). The DCI format 1_0 for downlink (DL) (e.g., Format 1_0 DL DCI) may comprise N₃ bits. The DCI format 0_0 for UL (e.g., Format 0_0 UL DCI) may comprise N₁ bits. The DCI format 0_0 for SUL (e.g., Format 0_0 SUL DCI) may comprise N₂ bits. The relationship among N₁, N₂ and N₃ may be N₃≥N₁>N₂. In this case, zero paddings will be applied to DCI format 0_0 in an event that the size of DCI format 0_1 (e.g., N₃) is greater than the size of DCI format 0_0 (e.g., N₁ and N₂). Since the size of the DCI format 0_0 for UL (e.g., Format 0_0 UL DCI) and the size of the DCI format 0_0 for SUL (e.g., Format 0_0 SUL DCI) are both smaller than the size of the DCI format 1_0 for DL (e.g., Format 1_0 DL DCI), the network node may add the zero-paddings to the end of the DCI format 0_0 for UL and DCI format 0_0 for SUL. For example, N₃−N₁ padded zeros may be added to the end of the DCI format 0_0 for UL. N₃−N₂ padded zeros may be added to the end of the DCI format 0_0 for SUL. In such case, the last bit of the DCI format 0_0 for SUL (e.g., “0”) is the same as the last bit of the DCI format 0_0 for UL (e.g., “0”). The UE may not know whether the UL/SUL indicator is configured or not. The UE may have difficult to determine whether such DCI is for the UL or the SUL.

In view of the above, the present disclosure proposes a number of schemes regarding DCI format design to avoid UL/SUL indicator bit ambiguity while applying padding to guarantee equal size of UL/SUL DCI sizes with respect to the UE and the network apparatus. According to the schemes of the present disclosure, the network apparatus may be configured to place the UL/SUL indicator at a fixed position in the DCI format. The UE may be able to identify/detect the UL/SUL indicator according to the fixed position of the DCI format and avoid ambiguity even when zero-padding is applied to the DCI format.

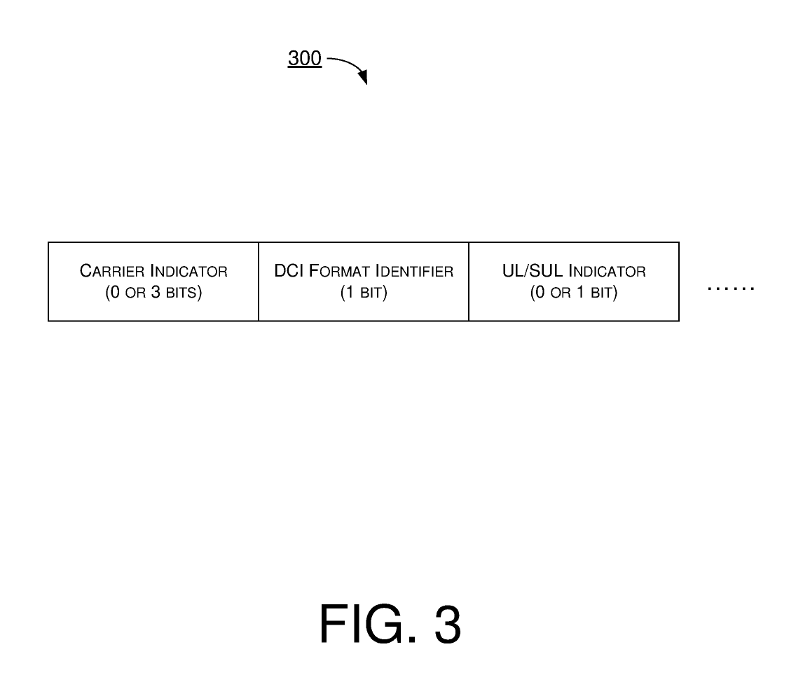

FIG. 3 illustrates an example scenario 300 under schemes in accordance with implementations of the present disclosure. Scenario 300 involves a UE and a network node, which may be a part of a wireless communication network (e.g., an LTE network, an LTE-Advanced network, an LTE-Advanced Pro network, a 5G network, an NR network, an IoT network or an NB-IoT network). The UE may be configured to camp on the network node. The network node may be configured to transmit DCI format to schedule DL or UL transmissions. The DCI format may comprise the DCI format 0_0 or the DCI format 0_1. The DCI format may comprise a plurality of information fields. For example, the DCI format may comprise a carrier indicator, a DCI format identifier and an UL/SUL indicator. The carrier indicator may comprise 0 or 3 bits and may be configured for monitoring physical downlink control channel (PDCCH) candidates. The DCI format identifier may comprise 1 bit for indicating an UL DCI format in an event that the value is set to 0. The UL/SUL indicator may comprise 0 or 1 bit. The UL/SUL indicator may comprise 0 bit when the UE is not configured with SUL in the cell or the UE is configured with SUL in the cell but only PUCCH carrier in the cell is configured for PUSCH transmission. The UL/SUL indicator may comprise 1 bit when the UE is configured with SUL in the cell.

The network node may be configured to place the UL/SUL indicator at a fixed position of the DCI format. The fixed position may be a front position of the DCI format or an end position of the DCI format. For example, the UL/SUL indicator may be placed after the carrier indicator and/or the DCI format identifier. The carrier indicator may be placed before the DCI format identifier (e.g., FIG. 3). Alternatively, the DCI format identifier may be placed before the carrier indicator.

Alternatively, the UL/SUL indicator may also be placed at any other position of the DCI format as long as the position of the UL/SUL indicator is fixed. The UL/SUL indicator may be placed at the end or any other positions fixed with respect to end after the zero padding to match DCI format sizes. For example, the UL/SUL indicator may be placed at the last bit position of the DCI format 0_0 after the padding bit(s).

Accordingly, after receiving the DCI format from the network node, the UE may be configured to retrieve the UL/SUL indicator from a fixed position of the DCI format. The UE may be able to determine whether the SUL is configured according to the indicator. In an event that the indicator comprises 0 bit, the UE may determine that the SUL is not configured. In an event that the indicator comprises 1 bit, the UE may determine that the SUL not configured. The UE may be configured to perform the PUSCH transmission according to the determination result.

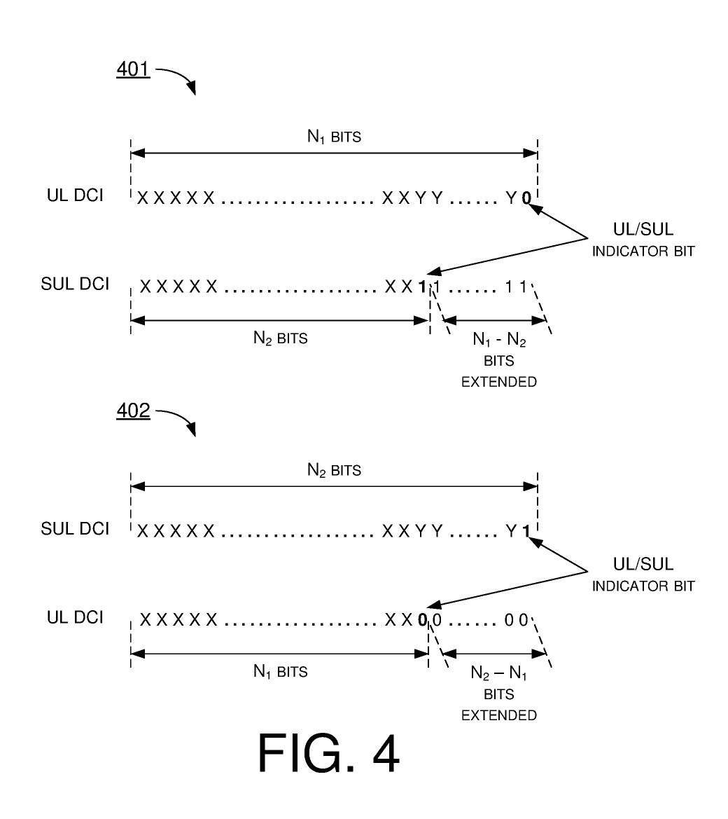

FIG. 4 illustrates example scenarios 401 and 402 under schemes in accordance with implementations of the present disclosure. Each of scenario 401 and 402 involves a UE and a network node, which may be a part of a wireless communication network (e.g., an LTE network, an LTE-Advanced network, an LTE-Advanced Pro network, a 5G network, an NR network, an IoT network or an NB-IoT network). Scenarios 401 and 402 illustrate an alternative scheme that the UL/SUL indicator may be bit extended to the end of the DCI format instead of zero padding in order to match the DCI size for UL/SUL DCIs. The DCI format may comprise the DCI format 0_0 or the DCI format 0_1. In scenario 401, the DCI for UL (e.g., UL DCI) may comprise N₁ bits. The DCI for SUL (e.g., SUL DCI) may comprise N₂ bits. N₁ may be greater than N₂. In such case, instead of adding zero paddings (e.g., N₁−N₂ bits) to the DCI for SUL, the network node may be configured to extend the UL/SUL indicator to the end of the DCI format (e.g., 11 . . . 11). By such scheme, the DCI size of the DCI for SUL may be matched with the DCI size of the DCI for UL and the last bit of the DCI for SUL may have the same value as the UL/SUL indicator. Accordingly, the UE may be able to determine whether the DCI is for UL or SUL according to the last bit of the received DCI format. The ambiguity due to the zero-padding may be avoided.

In scenario 402, the DCI for UL (e.g., UL DCI) may comprise N₁ bits. The DCI for SUL (e.g., SUL DCI) may comprise N₂ bits. N₁ may be less than or equal to N₂. In such case, instead of adding zero paddings (e.g., N₂−N₁ bits) to the DCI for UL, the network node may be configured to extend the last bit of DCI to the end of the DCI format (e.g., 00 . . . 00). By such scheme, the DCI size of the DCI for UL may be matched with the DCI size of the DCI for SUL and the last bit of the DCI for UL may have the same value as the UL/SUL indicator. Accordingly, the UE may be able to determine whether the DCI is for UL or SUL according to the last bit of the received DCI format. The ambiguity due to the zero-padding may be avoided.

Such scheme may be seen as padding by the repetitions of the UL/SUL indicator bit instead of the zero bits. In some implementations, other variations of the proposed schemes may also be used. For example, partial padding by the repetitions of UL/SUL indicator bit may achieve the same effect. The network node may be configured to replace only part of the zero padded bits by repetition of UL/SUL indicator bit. For example, in the case of scenario 200, it is enough to bit extend over the N₁−N₂ padded bits and not all the N₃−N₂ padded bits for the DCI format 0_0. Alternatively, the bit extension or the repetition of a single bit may be replaced by the repetition of multiple bits in an event that the indicator or the information needed to be identified at the end of the DCI format corresponds to multiple bits.

Illustrative Implementations

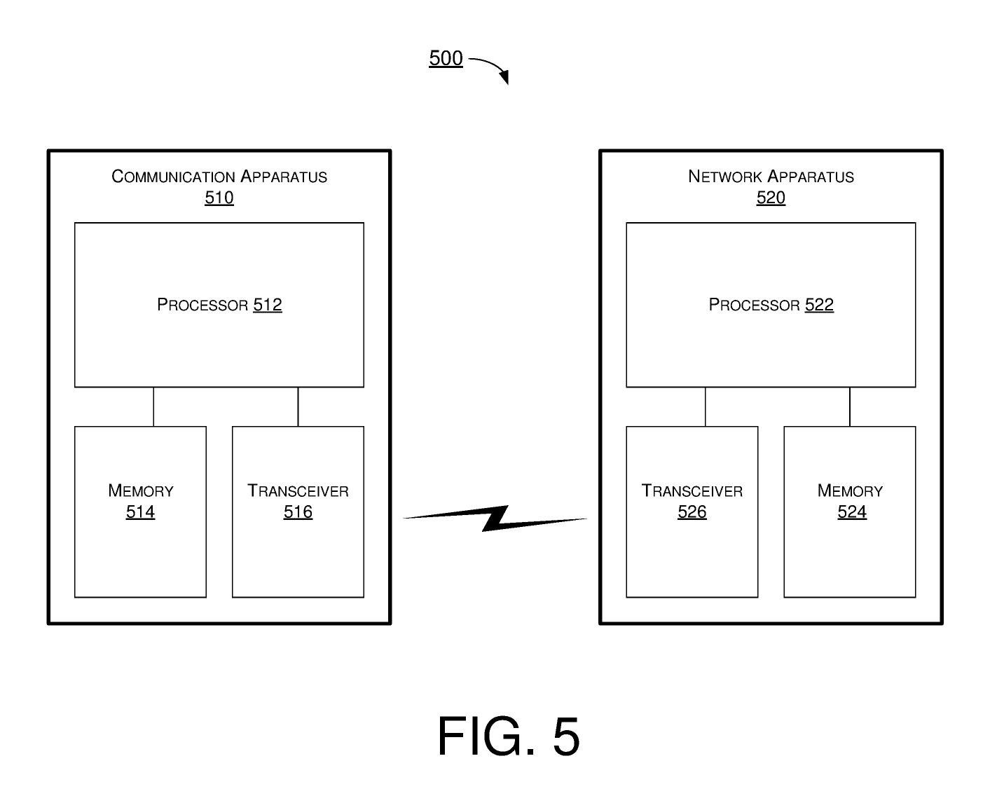

FIG. 5 illustrates an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to DCI format design with respect to user equipment and network apparatus in wireless communications, including scenarios 300, 401 and 402 described above as well as process 600 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT or NB-IoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a base station, a small cell, a router or a gateway. For instance, network apparatus 520 may be implemented in an eNodeB in an LTE, LTE-Advanced or LTE-Advanced Pro network or in a gNB in a 5G, NR, IoT or NB-IoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more RISC or CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including power consumption reduction in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

In some implementations, communication apparatus 510 may be configured to camp on network apparatus 520. Processor 522 may be configured to transmit, via transceiver 526, DCI format to schedule DL or UL transmissions to communication apparatus 510. Processor 522 may transmit, via transceiver 526, the DCI format 0_0 or the DCI format 0_1 to communication apparatus 510. Processor 522 may include a plurality of information fields in the DCI format. For example, processor 522 may include a carrier indicator, a DCI format identifier and an UL/SUL indicator in the DCI format. Processor 522 may use 0 or 3 bits for the carrier indicator. Processor 522 may use the carrier indicator to configure communication apparatus 510 for monitoring PDCCH candidates. Processor 522 may use 1 bit for the DCI format identifier. Processor 522 may set the value of the DCI format identifier to 0 to indicate an UL DCI format. Processor 522 may use 0 or 1 bit for the UL/SUL indicator. Processor 522 may use 0 bit for the UL/SUL indicator when communication apparatus 510 is not configured with SUL in the cell or communication apparatus 510 is configured with SUL in the cell but only PUCCH carrier in the cell is configured for PUSCH transmission. Processor 522 may use 1 bit for the UL/SUL indicator when communication apparatus 510 is configured with SUL in the cell.

In some implementations, processor 522 may be configured to place the UL/SUL indicator at a fixed position of the DCI format. Processor 522 may place the UL/SUL indicator at a front position of the DCI format or an end position of the DCI format. For example, processor 522 may place the UL/SUL indicator after the carrier indicator and/or the DCI format identifier. Processor 522 may place the carrier indicator in front of the DCI format identifier. Alternatively, processor 522 may place the DCI format identifier in front of the carrier indicator.

In some implementations, processor 522 may place the UL/SUL indicator at any other position of the DCI format as long as the position of the UL/SUL indicator is fixed. Processor 522 may place the UL/SUL indicator at the end or any other positions fixed with respect to end after the zero padding to match DCI format sizes. For example, processor 522 may place the UL/SUL indicator at the last bit position of the DCI format 0_0 after the padding bit(s).

In some implementations, after receiving the DCI format from network apparatus 520, processor 512 may be configured to retrieve the UL/SUL indicator from a fixed position of the DCI format. Processor 512 may be able to determine whether the SUL is configured according to the indicator. In an event that the indicator comprises 0 bit, processor 512 may determine that the SUL is not configured. In an event that the indicator comprises 1 bit, processor 512 may determine that the SUL not configured. Processor 512 may be configured to perform, via transceiver 516, the PUSCH transmission according to the determination result.

In some implementations, processor 522 may use bit extension to extend the UL/SUL indicator to the end of the DCI format instead of adding zero padding in order to match the DCI size for UL/SUL DCIs. Processor 522 may use bit extension scheme for the DCI format 0_0 or the DCI format 0_1. For example, processor 522 may use N₁ bits for the DCI for UL. Processor 522 may use N₂ bits for the DCI for SUL. N₁ may be greater than N₂. In such case, instead of adding zero paddings (e.g., N₁−N₂ bits) to the DCI for SUL, processor 522 may be configured to extend the UL/SUL indicator to the end of the DCI format. By such scheme, the DCI size of the DCI for SUL may be matched with the DCI size of the DCI for UL and the last bit of the DCI for SUL may have the same value as the UL/SUL indicator. Accordingly, processor 512 may be able to determine whether the DCI is for UL or SUL according to the last bit of the received DCI format.

In some implementations, processor 522 may use N₁ bits for the DCI for UL. Processor 522 may use N₂ bits for the DCI for SUL. N₁ may be less than or equal to N₂. In such case, instead of adding zero paddings (e.g., N₂−N₁ bits) to the DCI for UL, processor 522 may be configured to extend the last bit of DCI to the end of the DCI format. By such scheme, the DCI size of the DCI for UL may be matched with the DCI size of the DCI for SUL and the last bit of the DCI for UL may have the same value as the UL/SUL indicator. Accordingly, processor 512 may be able to determine whether the DCI is for UL or SUL according to the last bit of the received DCI format.

In some implementations, other variations of the proposed schemes may also be used. For example, partial padding by the repetitions of UL/SUL indicator bit may achieve the same effect. Processor 522 may be configured to replace only part of the zero padded bits by repetition of UL/SUL indicator bit. Alternatively, processor 522 may also replace the bit extension or the repetition of a single bit by the repetition of multiple bits in an event that the indicator or the information needed to be identified at the end of the DCI format corresponds to multiple bits.

### Illustrative Processes

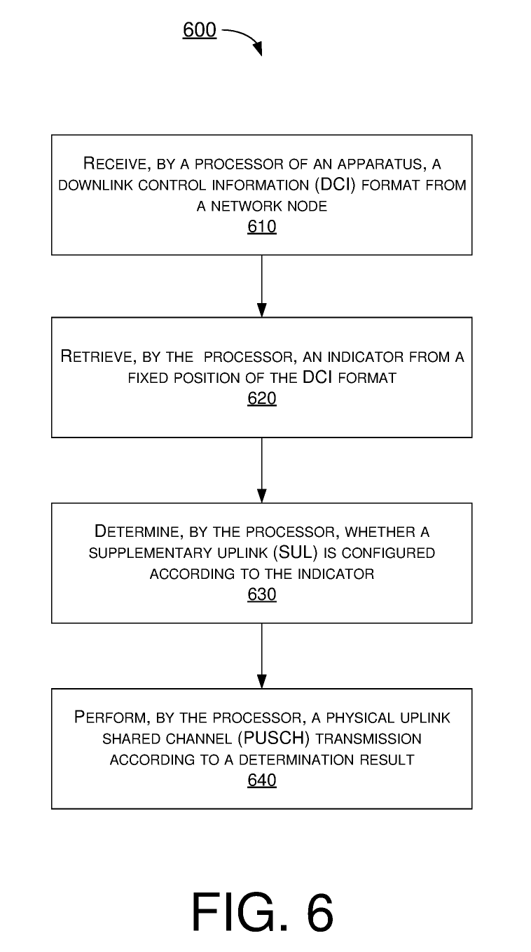

FIG. 6 illustrates an example process 600 in accordance with an implementation of the present disclosure. Process 600 may be an example implementation of scenarios 300, 401 and 402, whether partially or completely, with respect to DCI format design with the present disclosure. Process 600 may represent an aspect of implementation of features of communication apparatus 510. Process 600 may include one or more operations, actions, or functions as illustrated by one or more of blocks 610, 620, 630 and 640. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At 610, process 600 may involve processor 512 of apparatus 510 receiving a DCI format from a network node. Process 600 may proceed from 610 to 620.

At 620, process 600 may involve processor 512 retrieving an indicator from a fixed position of the DCI format. Process 600 may proceed from 620 to 630.

At 630, process 600 may involve processor 512 determining whether a SUL is configured according to the indicator. Process 600 may proceed from 630 to 640.

At 640, process 600 may involve processor 512 performing a PUSCH transmission according to a determination result.

In some implementations, the DCI format may comprise a DCI format 0_0, or a DCI format 0_1.

In some implementations, the fixed position may comprise a front position of the DCI format.

In some implementations, the fixed position may comprise an end position of the DCI format.

In some implementations, the fixed position may comprise a position after a carrier indicator or a DCI format identifier.

In some implementations, the fixed position may comprise a last bit position of the DCI format after at least one padding bit.

In some implementations, process 600 may involve processor 512 determining that the SUL is not configured in an event that the indicator comprises 0 bit.

In some implementations, process 600 may involve processor 512 determining that the SUL is configured in an event that the indicator comprises 1 bit.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink control information (DCI) format from a network node;
retrieving, by the processor, an indicator from a fixed position of the DCI format;
determining, by the processor, whether a supplementary uplink (SUL) is configured according to the indicator; and
performing, by the processor, a physical uplink shared channel (PUSCH) transmission according to a determination result.

2. The method of claim 1, wherein the DCI format comprises a DCI format 0_0, or a DCI format 0_1.

3. The method of claim 1, wherein the fixed position comprises a front position of the DCI format.

4. The method of claim 1, wherein the fixed position comprises an end position of the DCI format.

5. The method of claim 1, wherein the fixed position comprises a position after a carrier indicator or a DCI format identifier.

6. The method of claim 1, wherein the fixed position comprises a last bit position of the DCI format after at least one padding bit.

7. The method of claim 1, further comprising:
determining, by the processor, that the SUL is not configured in an event that the indicator comprises 0 bit.

8. The method of claim 1, further comprising:
determining, by the processor, that the SUL is configured in an event that the indicator comprises 1 bit.

9. An apparatus, comprising:
a transceiver capable of wirelessly communicating with a network node of a wireless network; and
a processor communicatively coupled to the transceiver, the processor capable of:
receiving, via the transceiver, a downlink control information (DCI) format from the network node;
retrieving an indicator from a fixed position of the DCI format;
determining whether a supplementary uplink (SUL) is configured according to the indicator; and
performing, via the transceiver, a physical uplink shared channel (PUSCH) transmission according to a determination result.

10. The apparatus of claim 9, wherein the DCI format comprises a DCI format 0_0, or a DCI format 0_1.

11. The apparatus of claim 9, wherein the fixed position comprises a front position of the DCI format.

12. The apparatus of claim 9, wherein the fixed position comprises an end position of the DCI format.

13. The apparatus of claim 9, wherein the fixed position comprises a position after a carrier indicator or a DCI format identifier.

14. The apparatus of claim 9, wherein the fixed position comprises a last bit position of the DCI format after at least one padding bit.

15. The apparatus of claim 9, wherein the processor is further capable of:
determining that the SUL is not configured in an event that the indicator comprises 0 bit.

16. The apparatus of claim 9, wherein the processor is further capable of:
determining that the SUL is configured in an event that the indicator comprises 1 bit.
